(19) United States
(12) Patent Application Publication
(10) Pub. No.: US 2015/0253969 A1
(43) Pub. Date: Sep. 10, 2015

(54) Apparatus and Method for Generating and Outputting an Interactive Image Object

(71) Applicant: Mitel Networks Corporation, Ottawa (CA)

(72) Inventors: Terry Tam, Ottawa (CA); Jim Davies, Arnprior (CA)

(73) Assignee: MITEL NETWORKS CORPORATION, Ottawa (CA)

(21) Appl. No.: 14/716,226

(22) Filed: May 19, 2015

Related U.S. Application Data
(63) Continuation-in-part of application No. 13/841,845, filed on Mar. 15, 2013, now abandoned.

(51) Int. Cl. G06F 3/0484; G06F 3/0482

(52) U.S. Cl. CPC G06F 3/04845; G06F 3/04847; G06F 3/04842; G06F 3/0482

(57) ABSTRACT

An apparatus and method are presented for generating and outputting an interactive image object for display using a graphical user interface. The interactive image object is associated with a computational workflow having a sequence of computational operations. A processor device is configured to determine a required computational operation for the workflow based upon a task request wherein the operation requires a user input. The processor generates the interactive image object.

### CROSS-REFERENCE TO RELATED APPLICATIONS

This application includes subject matter that is related to and claims priority from U.S. patent application Ser. No. 13/841,845 filed on Mar. 15, 2013.

### FIELD OF THE INVENTION

The present disclosure is in the field of workflow generation, in particular the generation and display of an interactive image object associated with a computational workflow comprising a sequence of computational operations.

### BACKGROUND OF THE INVENTION

Applications, such as search applications or applications that include a search function, often include a user client to receive a task request, such as a search request, employ an application to perform the task, and display the information in a predetermined or a user-selected format; the predetermined and user-selected formats generally include a limited number of predefined formats, having a predefined order for displaying the information. For example, the information may be displayed in a predefined “standard” format, an image view, a map view, a news view, or the like, wherein the order of the information is based on predefined criteria, such as a popularity of a website, sponsorship, or the like.

Although such applications work relatively well, the applications may not provide a user with information the user wants and the applications require that a user perform an additional step to display the information in a format other than a standard or a pre-selected format.

Accordingly, improved electronic methods and systems for viewing information in response to a task request are desired.

Graphical User Interfaces (GUI's) exist that allow users to input data to a computer system via an interactive element. The data can be inputs as part of a workflow consisting of a number of required operations. Some existing computational workflow systems can output a graphical object as an interactive form that provides a series of sections that are navigable through tabs. These sections each have a predefined template. The graphical object is therefore displayed with a number of interactive options such as tabs to other data input sections or a plurality of data input elements in the same visible section of the form being displayed. Some of these interactive options presented to the user may be unnecessary because of the type of workflow being undertaken. Furthermore, interactive options on one or more sections of a form may be made redundant due to the requested information already being made available or inferred from another input. Existing computational workflow systems may therefore generate and store unnecessary amounts of interactive image object data for the actual required workflow process. Furthermore different GUI displays may have difficulty outputting a standard workflow graphical object due to their size or display resolution. For example, the GUI display on a mobile phone may be hard to read due to overcrowding or the scaling down of image elements if the graphical object has numerous data and features.

### BRIEF DESCRIPTION OF THE FIGURES

Subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements and wherein:

FIG. 1 illustrates a system in accordance with exemplary embodiments of the disclosure.

FIG. 2 illustrates a table including presentation metadata associated with a task in accordance with additional exemplary embodiments of the disclosure.

FIG. 3 illustrates a presentation metadata grouping in accordance with exemplary embodiments of the disclosure.

FIG. 4 illustrates a sequence chart in accordance with additional exemplary embodiments of the disclosure.

FIG. 5 illustrates another sequence chart in accordance with yet additional embodiments of the disclosure.

FIG. 6 illustrates yet another sequence chart in accordance with additional embodiments of the disclosure.

FIG. 7 illustrates an apparatus system in accordance with exemplary embodiments of the disclosure.

FIGS. 8a and 8b show examples of workflows in accordance with exemplary embodiments of the disclosure.

FIG. 9 shows an example of a further workflow in accordance with exemplary embodiments of the disclosure.

FIG. 10 shows an example of a graphical image object in accordance with exemplary embodiments of the disclosure.

FIG. 11 shows an example of a graphical image object having multiple tabs for inputting user data in accordance with exemplary embodiments of the disclosure.

FIG. 12 shows an alternative representation of the graphical image object in FIG. 5, displayed in accordance with exemplary embodiments of the disclosure.

FIG. 13a shows an example of an image object having two tabs in accordance with exemplary embodiments of the disclosure.

FIG. 13b shows an alternative graphical object for outputting the image object shown in FIG. 7.

FIG. 13c shows a further alternative graphical image object for displaying a similar image object as shown in FIG. 7 in accordance with exemplary embodiments of the disclosure.

FIG. 14a shows an example of an image object having multiple tabs in accordance with exemplary embodiments of the disclosure.

FIG. 14b shows a similar output of the same graphical image object in accordance with exemplary embodiments of the disclosure.

FIG. 15 shows a graphical image object similar to that shown in FIGS. 8a and 8b in accordance with exemplary embodiments of the disclosure.

FIG. 16 shows a graphical image object in accordance with exemplary embodiments of the disclosure.

FIG. 17 shows a further example of an apparatus in communication with multiple portable devices in accordance with exemplary embodiments of the disclosure.

FIG. 18 shows a schematic example of an interactive image object in accordance with exemplary embodiments of the disclosure.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present invention.

### DETAILED DESCRIPTION OF EXEMPLARY EMBODIMENTS

The description of various embodiments of the present disclosure provided below is merely exemplary and is intended for purposes of illustration only; the following description is not intended to limit the scope of an invention disclosed herein. Moreover, recitation of multiple embodiments having stated features is not intended to exclude other embodiments having additional features or other embodiments incorporating different combinations of the stated features.

The disclosure describes exemplary electronic systems and methods for determining a context of a task entered by a user or as a result of an application launch and displaying information based on the context of the task. As set forth in more detail below, a configuration of displayed information, including a layout of the information (e.g., table, tree, or the like), a formatting of the information (e.g., language, numeric formatting, or the like), and/or a sort order of the information may be based on the context of a task. For example, in the context of a search task, search results for “images for the Mona Lisa” may be automatically displayed differently from search results for “location of the Mona Lisa.” Similarly, in the context of applications, a user interface may display differently upon launch of an application, depending on the context from which the application is launched—e.g., whether it was launched from a particular application or type of application.

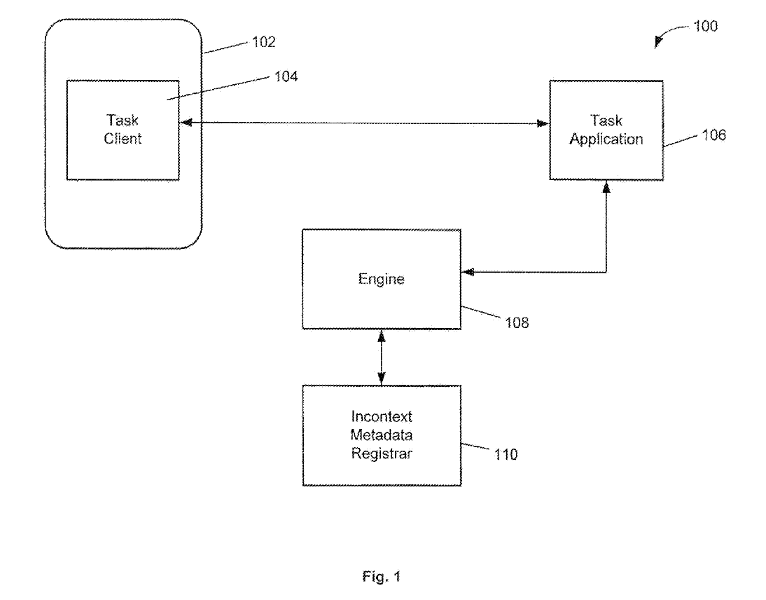

FIG. 1 illustrates a system 100 for displaying information based on a context of a task in accordance with various exemplary embodiments of the invention. System 100 includes a user device 102, a task client 104 on user device 102, a task application 106, an engine 108 (e.g., a comparison engine, a natural language interpreter, artificial intelligence, a learning engine, or the like), and an incontext metadata registrar 110. Task client and user client are used interchangeably herein.

Although illustrated as separate units, task client 104, task application 106, engine 108, incontext metadata registrar 110, and/or various combinations thereof may form part of the same application and/or reside on the same device (e.g., device 102). Alternatively, task client 104, task application 106, engine 108, and incontext metadata registrar may reside on two or more separate devices. By way of example, task client 104 may reside on user device 102 and task application 106 may reside on a server, another computer, another device, or the like, and engine 108 and incontext metadata registrar may reside on the same or separate devices as task application 106.

As used herein, the term “application” refers to coded instructions executable by a processor that can be used to perform singular or multiple related tasks. For example, an application may include enterprise software, medical records software, graphic player, media players, or any other suitable software. The application may be an independently operable application or form part of another application. By way of one example, task application 106 is part of an enterprise system, which can be accessed within the enterprise system, but which can also operate independently of the enterprise system.

Device 102 may include any suitable electronic device, such as a smart phone, a tablet computer, a personal computer, a work station, a server, a conference unit, or any other device that includes a user interface to allow a user to enter a task and a display for displaying information based on the context of the task entered by a user.

Device 102 may be a stand-alone device or may be coupled to a network using wired or wireless technologies and task application 106, engine 108, and/or incontext metadata registrar 110 may form part of the network (e.g., one or more may reside on a server within a network). Exemplary networks include a local area network (LAN), a wide area network, a personal area network, a campus area network, a metropolitan area network, a global area network, or the like. Device 102 may be coupled to the network using, for example, an Ethernet connection, other wired connections, a WiFi interface, mobile telecommunication technology, other wireless interfaces, or the like. Similarly, the network may be coupled to other networks and/or to other devices typically coupled to networks.

Task client 104 allows a user to enter a task using device 102 and a suitable user interface. For example, a user may use a keyboard, mouse, or touchscreen to enter a task using client 104.

Task application 106 is an application that performs a function in response to a task. Exemplary tasks include launching an application, performing a search, and the like.

Engine 108 uses a processor to compare a task to data stored in incontext metadata registrar 110. Engine 108 determines whether there is an actual or inferred match to data in incontext metadata registrar 110, and if there is a match, displaying information based on the context of the task. If a match is not found, engine 108 may infer a display configuration to use to display the information.

Incontext metadata registrar 110 stores information corresponding to various display configurations, which correlates to a context of a task. The display configuration information may correlate to a set of one or more predefined tasks and/or may correlate to inferred tasks.

United States Publication No. 2012/0179706 to Hobbs et al., published Jul. 12, 2012, entitled “Contextual application launch via search query”, discloses a technique to determine a context of a search, which may be used to determine a task context as described herein. The contents of U.S. Publication No. 2012/0179706 are incorporated herein by reference, to the extent the contents do not conflict with the present disclosure.

In an exemplary system, a context of a task may be obtained by comparing objects (e.g., nouns) and actions (e.g., verbs) of a task (e.g., entered by a user using task client 104) to objects and/or actions stored in incontext metadata registrar 110. Although at least one of objects and actions may be stored in incontext metadata registrar 110, the system may desirably store at least actions, since objects are more likely to change over time. Incontext metadata registrar 110 may be in a variety of configurations, such as a random access transient metadata store.

One technique that may be used to populate incontext metadata registrar 110 with information includes using task application 106 or other application(s) to populate incontext metadata registrar 110. The application(s) may communicate actions that can be performed by the respective applications and these actions can be stored in incontext metadata registrar 110. The data may be communicated in an unsolicited or a solicited manner. For example, the application(s) may include a search application that uses a search engine to crawl websites, hard drives, and the like and index files that are found. Or, another application can send information relating to tasks that the application can perform to a search application, such that the search application can search data having objects and/or actions relevant to the application(s). Other techniques for registering information in incontext metadata registrar 110 include learning operations, where information may be added to incontext metadata registrar 110 from a learning engine. Additionally or alternatively, if the system does not recognize a context, the system may display options for a display configuration to a user to allow a user to select a display configuration. The system may be designed to learn from such user selections.

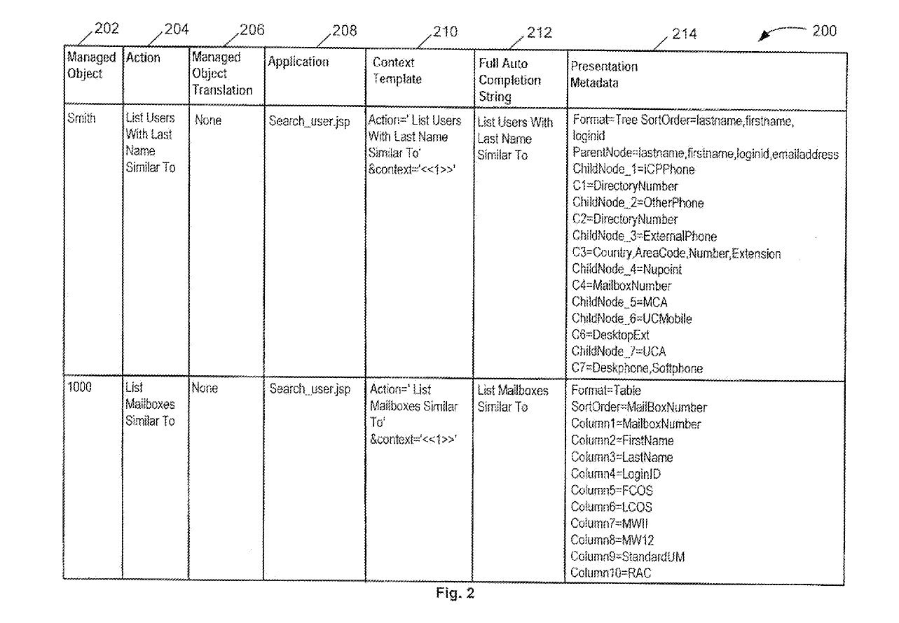

FIG. 2 illustrates a table 200 of exemplary registration data (e.g., stored in incontext metadata registrar 110), with metadata to drive a task (a search query in the illustrated example) to action and presentation metadata, with additional information for normalization, thesaurus mapping, auto-completion, and contextual application launch. Table 200 includes fields for Managed Objects 202, Actions 204, Managed Object Translation 206, Application 208, Context Template 210, Full Auto Completion String 212, and Presentation Metadata 214.

For simplicity, the example illustrated in FIG. 2 is for a single presentation action. Examples of multiple presentation metadata per Action 204 are discussed below.

Presentation Metadata 214 may be registered using any of the techniques described above. Further, Presentation Metadata 214 can be used to easily maintain consistency of user interface presentation of information across various device formats and between various applications on a system or a cluster of systems to provide a common integrated look and feel to a user.

In accordance with various embodiments of the disclosure, Presentation Metadata 214 is used to inform an application (e.g., task application 106) how to display information once the information is determined from an Action 204 (e.g., a search). For example, Presentation Metadata 214 can inform an Application 208 to display information in one or more of a tree format, a list, a table, etc., and to sort information based on occurrences of the information, based on advertising or sponsorship, or the like.

As noted above, the examples illustrated in FIG. 2 relate to a task that is a search. The first illustrated task is searching for persons with a last name similar to an entered object. The second example is a search for mailboxes similar to a mailbox number pattern for a user-entered object. In the illustrated cases, the object is dynamic and the managed object replaces the <<1>> token for the operation.

In the first example, for an operation to “list users with a last name similar to smith,” the system calls a user and services search Application called Seach_user.jsp with the corresponding Context Template. The Application may query for Presentation Metadata and discover that the results of the query should be displayed, in the illustrated example, in a tree format with user information as the parent node and the user's corresponding services as child nodes. In the illustrated example, the sort order is based on last name, then first name, then login identification.

In the second example illustrated in FIG. 2 to “list mailboxes similar to 1000,” the Search_user.jsp application is called and information is displayed in a table format, sorted by mailbox number and the column lists are based on the associated Presentation Metadata in table 200.

As noted above, multiple presentation metadata may be associated with a search context (e.g., an action and/or object). Using multiple presentation metadata templates may be desirable, for example, when an application may be run on devices with different display formats—e.g., a mobile device and a desktop device. For example, a user's workflow may be limited due to, for example, user interface restrictions of the mobile device. And, the display format and the amount of information that may be displayed on a mobile device may be less compared to a desktop or similar device.

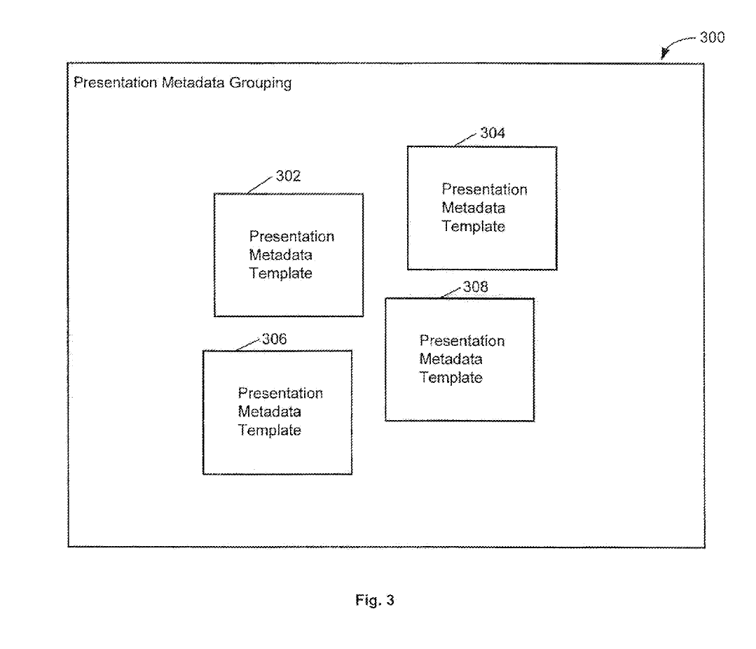

FIG. 3 illustrates a presentation metadata grouping 300 for supporting multiple presentation metadata templates 302-308, which can be used for displaying information in different configurations—e.g., each grouping 300 is suitable for a desktop, mobile device, or other device. Each template 302-308 within a grouping 300 may correspond to a different display configuration for a given context.

Table 1, below, illustrates a presentation metadata grouping, which includes two unique identifiers: one for rapid identification internally in a system (e.g., a universally unique identifier (UUID) and a second for a human readable unique string, which allows for a consistent user interface display to a user when identifying the grouping). In the illustrated example, the grouping also includes a list of presentation metadata template identifiers to identify which templates are in the group.

TABLE 1

| Elements | Description |
|---|---|
| PresentationGroupingID | Universally unique identifier identifying |
| | the grouping |
| PresentationGroupingName | Human readable unique identifier |
| | representing the presentation |
| | metadata grouping |
| PresentationTemplateList | A list of PresentationTemplateID |
| | detailing which templates belong to the |
| | grouping |

Table 2 illustrates an exemplary format of the presentation metadata template. The exemplary template includes a set of two unique identifiers and a non-restrictive rule set with enough information to help an application determine if the template is suitable for the application. Exemplary rules include what type of device is in use (e.g., mobile, desktop, etc.), which application context is servicing the task (e.g., was the task from an independent application or not), and the like.

| Elements | Description |
|---|---|
| PresentationTemplateID | Universally unique identifier identifying |
| | the presentation metadata template |
| PresentationTemplateName | Human readable unique identifier |
| | representing the presentation metadata |
| | template |
| PresentationRuleSet | A description of when the template is |
| | applicable to help an application |
| | automatically determine which template |
| | to use if there is more than one template |
| | in the grouping |
| PresentationFormat | A series of elements describing the |
| | preferred formatting. An example is the |
| | name value pair set of parameters listed |
| | in FIG. 2 for the “List Users With Last |
| | Name Similar To” verb (action) |

As noted above, a task may be initiated from various applications. Accordingly, in accordance with some embodiments of the disclosure, a list of applications may be available to service an action or object using a common framework/process. In other words, the application column in table 200 may include more than one application per action (or object).

Template metadata may also include a non-restrictive list of elements describing the formatting for the presentation of the information. Exemplary elements include display format, such as tree, table, or list, sort order information, and which information to display and in which order to display the information.

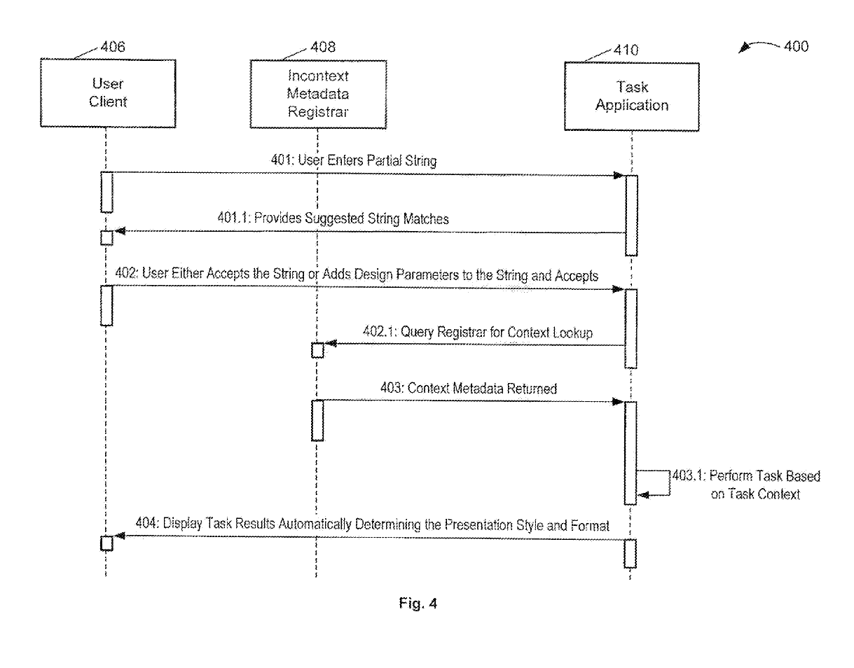

Turning now to FIG. 4, an exemplary method or sequence overview 400 for displaying information based on a context of a task is illustrated. Method 400 includes a user entering a task or partial task (401) using a user client 406, optionally, an application providing a suggested string or strings (401.1), optionally, a user accepting the string or adding desired parameters to the string (402), querying an incontext metadata registrar 408 for context lookup (402.1), sending context metadata to a task application 410 (403), performing a task (403.1), and displaying task information based on the context of the task, wherein a configuration of the displayed information (e.g., style, format, and/or content) depends on the context of the search.

In the illustrated example, a user enters a query using task or user client 406 on a device (e.g., device 102) (401.1). The task may be text based, speech recognition based, image recognition based, or the like. The query may be a partial string, in which case an application (e.g., task application 410) may return one or more suggested strings for the task (401.1). The user may edit and complete the task string as desired using user client 406 and pass the completed string back to application 410 (402). Application 410 then queries incontext metadata registrar 408 to determine a context of the task, what, if any dynamic parameters are present in the string, and corresponding presentation metadata template to use. Application 410 then performs a task (e.g., a search) (403.1) and automatically displays the information resulting from the task in a configuration corresponding to the presentation metadata.

FIG. 5 illustrates another method or sequence overview 500 for displaying information based on a context of a task. In this case, a configuration of information display is a function of an application launch in context (described in more detail below). Method 500 includes the steps of launching an application 510 (501), querying for presentation metadata in an incontext metadata registrar 506 (501.1), sending presentation metadata to application 510 (502), and sending presentation information to a user client 504 to display application information in a configuration that corresponds to a context of the task. Method 500 may additionally include steps of registering data in an incontext search registrar, a user entering a task using a task client, an application or registrar providing a suggested string or strings, and a user accepting the string or adding desired parameters to the string, as described herein in connection with method 400 and method 600.

In accordance with the method illustrated in FIG. 5, when application 510 launches, the application queries incontext metadata registrar 506 prior to presenting information to a user. In this case, application 510 can automatically determine the best configuration to present information to a user based on a context of a task.

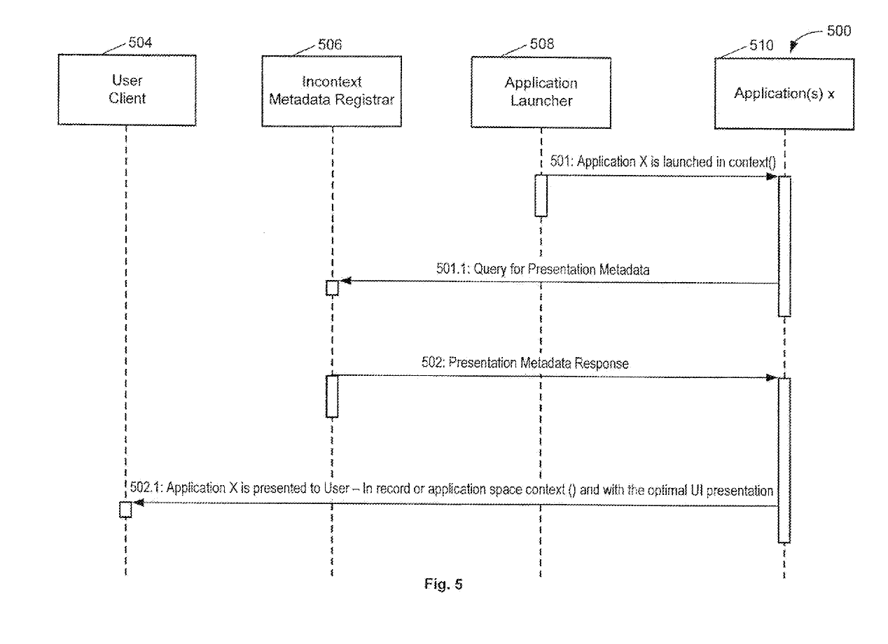

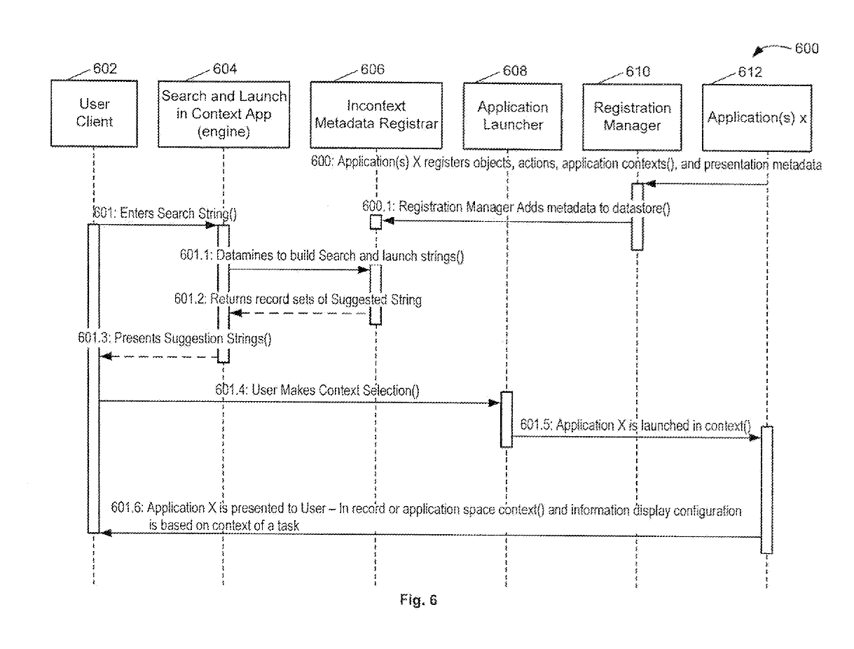

FIG. 6 illustrates another method 600 in accordance with yet additional exemplary embodiments of the disclosure. Method 600 includes a registration process (600) followed by a search and launch operation (601) that includes displaying application information in a configuration that depends on a context of a task.

In the illustrated example, registration begins with registering metadata with an incontext metadata registrar 606 based on registration information from one or more applications 612. Applications 612 may register data stores of objects and actions, as well as action mapping during step 600.

A search string is entered using a user client 602 during step (601). A Search and Launch in Context Application 604 can data mine Incontext Metadata Registrar 606 to build search and launch strings. Search and Launch in Context Application 604 can perform data mining or querying of the registered metadata data store(s) based on the user input received during step (601).

At step 601.2, Incontext Metadata Registrar 606 can return record sets of suggested strings and in context tokens to the Search and Launch in Context Application 604.

At step 601.3, a user is optionally presented with a suggested string. Next, a user can accept or amend and accept the proposed string, and the string can be sent to an Application Launcher 608 (601.4). Application Launcher 608 may then formulate appropriate arguments to build the launch context for the selected application and launch the target Application 612 (601.5). User client 602 may then be presented with Application 612, wherein Application 612 information display configuration is based on a context of the task or search.

The systems and methods described herein can be used to display information based on a context of a task and can be further configured to launch one or more desired applications based on a task. The systems and methods have been described above in connection with various tasks, including searches. Exemplary methods and systems may be used in connection with other tasks, such as automatically configuring a display and/or workflow based on a context from which an application is launched.

The methods and systems disclosed herein are advantageous over similar systems that require a user to manually input a desired display format, because the systems and methods do not require the additional step. The methods and systems can determine a context of a task (e.g., a search or a context of an application launch) and display information based on the context of the task. For example, the methods and systems can determine whether a search response view, a standard view, an image listing view, a video listing view, or a news listing view is more appropriate and then automatically display the task information in an appropriate configuration or view. Furthermore, the systems and methods described herein can display more relevant information related to the task and display information that is more suitable to a user device, compared to typical systems.

For example, a method and system can be used to provide dynamic rendering of a user interface of an application or a database. The method and system can determine a context, e.g., using one or the techniques described herein, and based on the context, different menus, fields, and parameters of an application's user interface can be displayed to a user on a user device, depending on, for example, likely desired tasks or workflows induced from metadata corresponding to the context of the task.

The systems and methods described herein can be used by accounts administrator. In this case, a search on user identifications, cell phone number, and office phone number might result in a mobile twinning workflow to be used, while a search for user identifications, available DiDs, or free licenses might invoke an add a new user workflow. In these and similar examples, workflows could be either pre-configured, that is anticipated by the developer or dynamically created based completely on the search context—e.g., using a learning engine as described above. Pre-configured workflows have advantage of including additional parameters and fields that the user will likely use beyond those included in the search criteria. Dynamic workflows would allow the application user or administrator to have an optimized user interface experience based on the context, even in workflows and scenario's not directly anticipated by the developer. The user interface could be completely constructed from the search context or user task.

A specific example of using the system and method described herein is a dynamic rendering of a quick add application in a suite product. A typical quick add application might walk an administrator through a provisioning flow to add services to an end user. Static templates are created manually ahead of time by the administrator to outline which services are available for an end user on a per template basis. To add services to a user, the administrator will select an appropriate template for the user at the start of the quick add application, and the quick add application would present an optimized workflow for the administrator to complete the task. Manually creating the static templates is time consuming and complex to manage, especially in the case where there is a large matrix of various services that end users can have. The methods and systems described herein can solve this problem by dynamically creating the templates for a quick add or similar application dynamically based on context of the search or task.

In a case where the administrator provides the following task: “find all users with no services and add office phone and voicemail,” a system and method as described herein, may determine that the search user application will need to be launched to allow an administrator to fine tune a result set that contains a list of all users with no services. The result set would then feed into a quick add application. Extending the available metadata in FIG. 2, an exemplary method and system can dynamically create a template required by the quick add application. In this case, a template requesting an office phone and a voicemail service can be generated.

The systems and methods described herein can also be used in a Medical ERP system. In this case, a medical administrator can perform a search on patient name, available rooms and doctor name, and the user interface could be for the “admit patient” workflow which over above the explicitly queried fields provides additional data (e.g., health plan coverage, special diet needs, etc.) and the series of appropriate admit menu actions for admissions. And, the system could be configured such that if an administrator searches on patient name, doctor name, and outstanding test requests, the user interface could be tuned to the “book an appointment” workflow.

There is presented an apparatus 1002 for generating and outputting an interactive image object 1048 for display using a graphical user interface (GUI) 1006. The interactive image object 1048 is associated with a computational workflow 1008. The computational workflow 1008 comprises a sequence of computational operations 1010. The apparatus 1002 comprises a processor device 1012. The processor device 1012 (also referred to herein as a ‘processor’ 1012) is configured to determine a required computational operation 1010 for the workflow 1008 based upon a task request 1014. The required computational operation 1010 requires a user input 1028. The processor 1012 is also configured to generate the interactive image object 1048: firstly, based upon any one or more of the determined computation operation 1010 or the required user input 1028; and secondly, by applying, based on context data associated with the workflow 1008, one or more object generation rules determining the configuration of the interactive image object 1048. The processor 1012 is further configured to output the interactive image object 1048 for display.

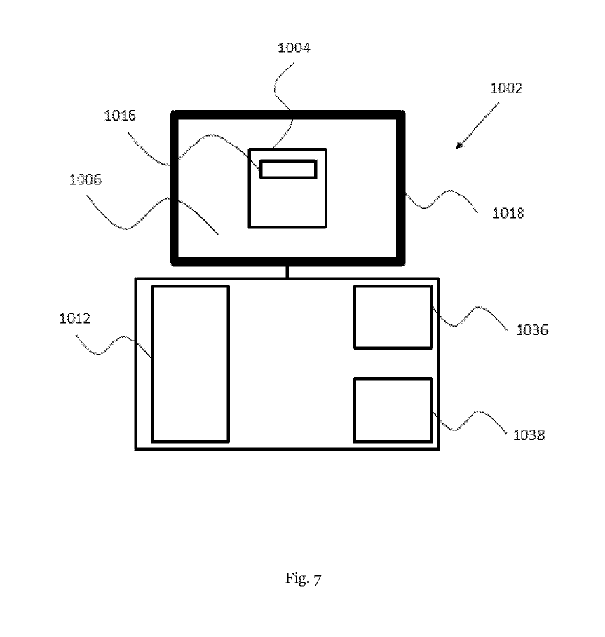

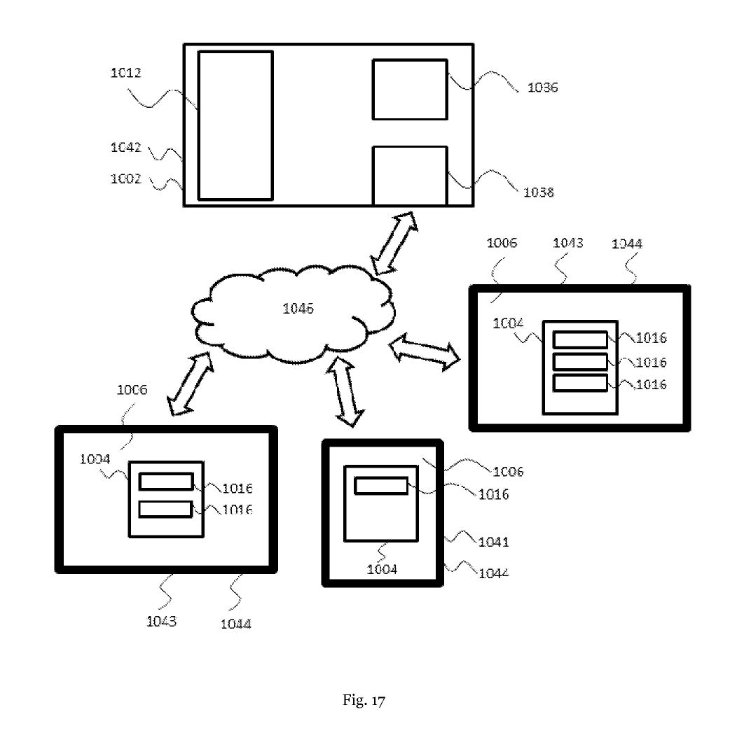

The processor 1012 may, for example, output the interactive image object 1048 for display by passing the interactive image object 1048 (or data associated with the object) to one or more display devices 1018 that form part of the apparatus 1002 as shown in FIG. 7. Additionally or alternatively, the apparatus 1002 may output the interactive image object 1048 data to an output device 1038 such as a communications device, which in turn sends the interactive image object 1048 to one or more remote devices (such as portable device 1044) for display as shown in FIG. 17. Such portable devices 1044 may be, for example, tablets 1043 or mobile phones 1041 with a display device for hosting a GUI 1006. Each of these portable devices 1044 may have a communications device configured to receive the interactive image object 1048 and send data back to the apparatus 1002. In one example the apparatus 1002 is a server 1042 comprising one or more processor devices 1012, one or more memory devices 1036 and data input/output devices 1038. The server 1042 and the one or more portable devices may 1044 may communicate via a network 1046, for example communication using the internet. Additionally or alternatively the apparatus 1002 may be in communication with one or more static computational devices (not shown in FIG. 17) that have a display for hosting a GUI 1006. An example of a static device is a desktop Personal Computer (PC).

The apparatus 1002 may be part of a system. The system may comprise the apparatus 1002 and one or more remote device comprising a display 1018 for hosting a GUI 1006.

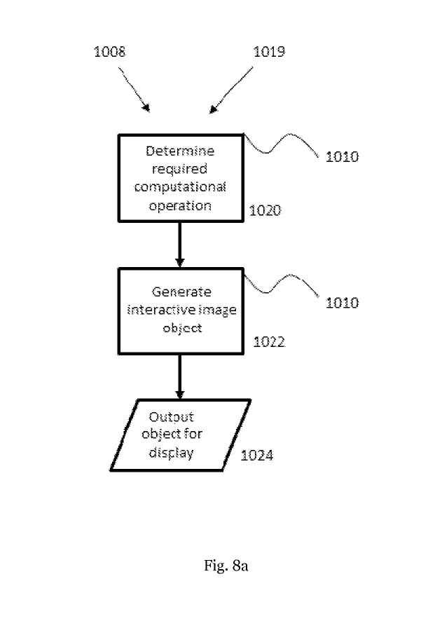

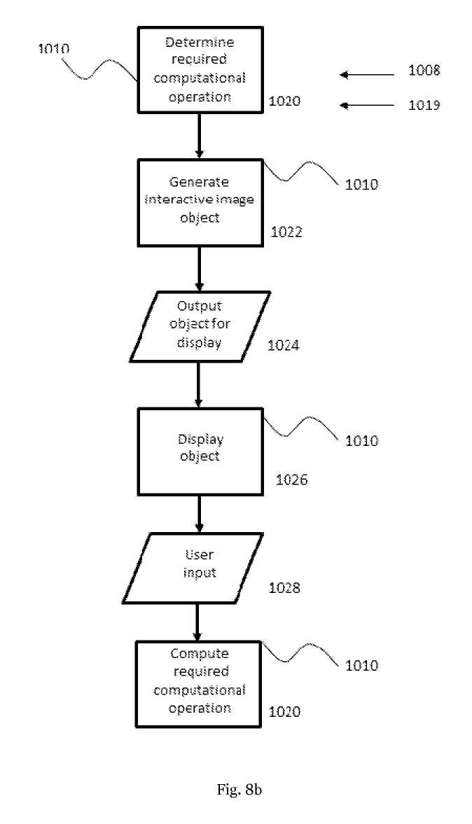

There is also presented herein a method 1019 for generating and outputting an interactive image object 1048 for display using a graphical user interface 1006, an example of which is shown in FIG. 8a. The interactive image object 1048 is associated with a computational workflow 1008 comprising a sequence of computational operations 1010. The method 1019 comprises the steps of, firstly, determining 1020 a required computational operation 1010 for the workflow 1008 based upon a task request 1014, where the operation 1010 requires a user input 1028. The method then, secondly, generates 1022 the interactive image object 1048: based upon any one or more of the determined computational operation 1010 or the required user input 1028 and, by applying, based on context data associated with the workflow 1008, one or more object generation rules determining the configuration of the interactive image object 1048. The method then, thirdly, outputs 1024 the interactive image object 1048 for display.

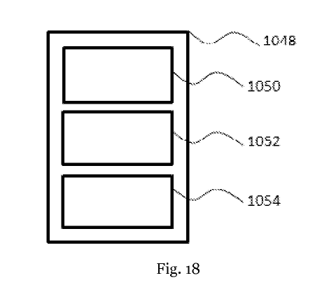

When displayed by the GUI 1006, the interactive image object 1048 appears as a graphical image object 1004 having an interactive graphical image element 1016 for receiving the user input 1028. The interactive image object 1048 comprises image data 1050 for defining the graphical image object 1004 and interactive data (such as accompanying metadata) 1052 associated with the interactive graphical image element 1016 for receiving the required user input 1028. An example of an interactive image object 1048 is shown in FIG. 18. The interactive image object 1048 in this example also optionally comprises other data 1054, for example data associated with the performance of the workflow that is not specifically associated with graphical objects 1004 and their interactive elements 1016. Such other data may be communication based data, for example data instructing a remote device 1044 to only output the received user data back to the server 1042 after a particular period of time. Another example of other data may be temporary or permanent code to reside on a remote device 10 that allows the processor in the remote device 1044 to locally generate a subset of workflow steps.

The apparatus 1002 therefore generates the interactive image object 1048 based upon the task request and context data associated with the workflow 1008. In this manner the apparatus 1002 may not need to upload a predefined template defining the graphical image object 1004 seen by a user viewing the GUI 1006, but instead creates interactive image objects 1048 (that defines the graphical image objects 1004) as the workflow 1008 continues from step to step. This allows the workflow 1008 to be dynamic and adaptable to what is required at each computational step 1010. Such a dynamic approach may include requiring fewer or greater numbers of user inputs being displayed to the user at any given time. For example, an input task request 1014 indicates a particular computational operation 1010 is required. This computational operation 1010 requires ten user inputs 1028. Rather than displaying a form on the GUI 1006 with ten user input data fields, the apparatus 1002 subdivides the operation 1010 into a plurality of sub-operations that are completed in sequence wherein each sub-operation displays a graphical data input field 1016 for one or more of the required ten user inputs 1028. In this manner, a nominal single step in the workflow 1008 that would have been output as a single graphical image object, has been divided into multiple steps. Each workflow step in this example is associated with the generation of a new interactive image object 1048 that is sequentially output to the apparatus hosting the GUI 1006 wherein each interactive image object 1048 displays only a portion of the original ten interactive graphical image elements 1016. Such a situation may occur when, for example, context data is provided that indicates the user has been interacting with the workflow 1008 for a long time and, as such, the likelihood of the user losing concentration will have increased. By making a nominally large complex workflow step into several smaller easy to manage steps, the user is less likely to make a mistake. The adaptability of the workflow 1008 in this example may be realised by context data (used by an object generation rule) calculated by the apparatus's 1002 internal clock monitoring the workflow 1008. The rule determines the number of interactive graphical image elements 1016 for each output interactive image object 1048 as a function of workflow duration. For example, the rule may limit each interactive image object 1048 to output only up to two interactive graphical image elements 1016 when the workflow 1008 has been running for over one hour.

The apparatus 1002 and method 1019 may also provide that unnecessary data or options are not presented to the user if those options are not required for a particular computational step 1010. Creating the interactive image object 1048 to be displayed on the graphical user interface 1006 as a graphical image object 1004 (with an interactive image element 1016) without using a predefined template therefore allows the method 1019 and apparatus 1002 to not require predefined object images. This may save computational memory in storing such images. Such interactive image objects 1048 may have fewer lines of code to send to a rendering engine than an interactive image object 1048 with multiple levels of functionality. These advantages become increasingly apparent from large complex workflows 1008 where multiple steps require multiple user inputs 1028 and with workflows 1008 being operated with simple computational devices with limited graphical processing capability.

The apparatus 1002 and method 1019 also allow the workflow 1008 and display of the workflow 1008 to be adaptable to the current circumstances surrounding the execution of the workflow 1008. For example, context data may be received by the method 1019 or apparatus 1002 that indicates the user running through the workflow 1008 has poor visibility. Such context data may therefore by used by an object generation rule to limit the amount of information displayed by the graphical image object 1004 on the graphical user interface 1006. In such circumstances the one or more interactive graphical elements 1016 that the workflow 1008 outputs on a display device 1018 accommodating the graphical user interface 1006 is configured to manage the user's particular circumstances.

Other advantages and features that may be associated with the apparatus 1002 and method 1019 are described herein with different examples. Unless specifically stated to the contrary, features used in examples describing the apparatus 1002 and method 1019 may be used in any other configurations of the apparatus 1002 and method 1019 described herein. The following sections detail some examples of how the apparatus 1002 and method 1019 may be configured.

### Task Request

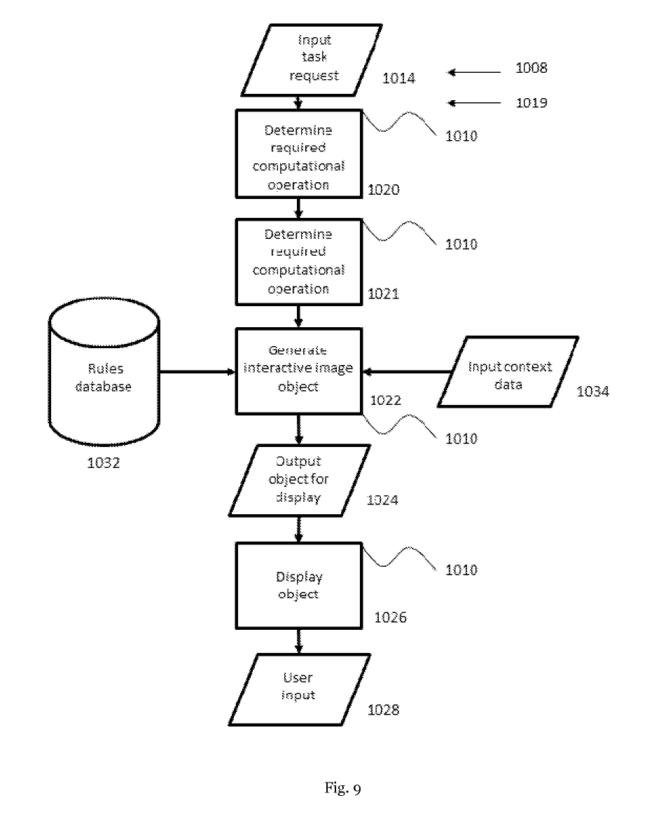

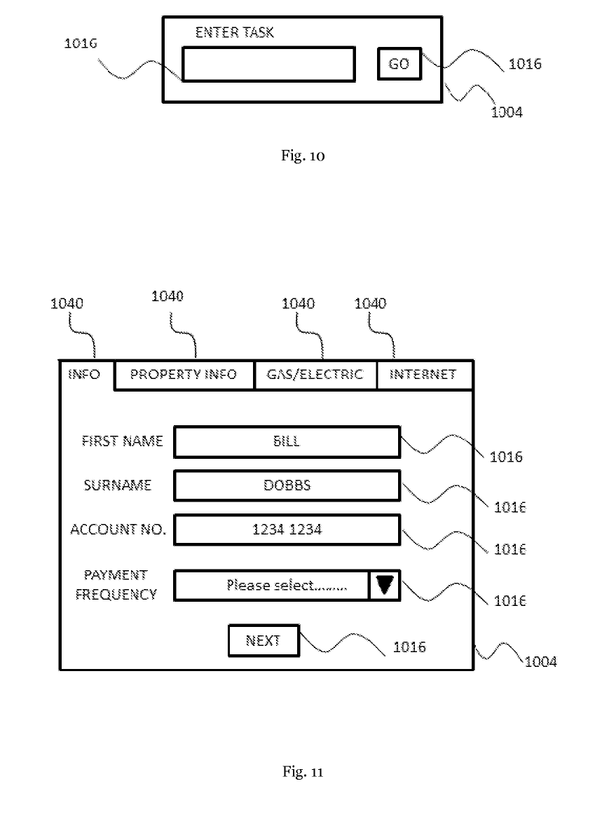

The task request 1014 may be any task request 1014 in principle that requires the workflow 1008 to take another step that requires a user input 1028. The task request 1014 may be user generated, for example being input by a user as exemplified in FIG. 10. This input may be a direct instruction by the user to perform a particular task or the input may be part of a previous step in the same workflow 1008, wherein the workflow 1008 processed the previous user input 1028 and generated the new task as part of the processing output. Alternatively, the task request 1014 may be automatically generated by a computer device such as the apparatus 1002 described herein. In this ‘automatic’ example the task generation may be performed upon receiving one or more input stimuli such as a user turning on a computer device or another input such as a particular time being reached that signifies the workflow 1008 should be started. Task requests 10014 may include a plurality of sub-tasks. Other examples of task requests 1014 are described elsewhere herein.

### Computational Workflow and Computational Operations

The workflow 1008 comprises a series of activities or ‘steps’ that are necessary to complete an overall task. These activities comprise a plurality of computational operations 1010 performed using at least one computer device such as the processor device 1012 described herein. The required computational operation 1010 determined by the method 1019 and apparatus 1002 is a future computational operation that is necessary to complete the task associated with the task request 1014.

An overall task may be termed a global task and may have a number of task requests 1014 associated with it. For example the global task is to compute the suitability of a person for employment by a particular company. The global task includes a task for establishing the person's personality through online questions and answers (Q&A) and another task for establishing the person's background details. Each task may have a number of subtasks for example, establishing the personality data by a series of Q&A online forms that the candidate has to complete. There may therefore be a hierarchy of tasks that directly impact how computational operations 1010, hence the workflow 1008 are managed. Further to the employment example described above, the apparatus 1002 may configure the workflow 1008 depending on the time it takes for the person to complete a personality test. The test may require the candidate to complete all the sub tasks of completing each question within a set time, wherein the default state for the workflow 1008 is to generate interactive image objects 1048 that are configured to only display one graphical image object 1004 (with one interactive graphical image element 1016) at a time. If context data is determined that the user is running out of time, then the apparatus 1002 may begin to increase the number of user inputs (hence interactive graphical elements 1016) per interactive image object so that the user sees two or more questions per instance of a user interface page. In this example, context data may be determined by obtaining information about the current duration of the personality test task and comparing this data to existing data associated with the task (such as the maximum time the candidate has).

The workflow 1008 can be represented by different steps and actions including those represented by standard flowchart actions and symbols. Such flowchart symbols may relate to actions such as decision steps, start/end terminators, inputs and outputs, delays, display, manual input, and stored data. With the exception of the first steps, each step in a workflow 1008 has a specific step before it and a specific step after it (apart from the last step). The workflow 1008 may be a linear workflow wherein the first step is typically initiated by an outside initiating event. The workflow 1008 may additionally or alternatively comprise a loop structure where a first step is initiated by completion of a last or subsequent step. Some of the steps in the workflow 8 may be computational in nature in that they require a computational operation 1010 using the processor 1012. Other steps in the workflow 1008 may be non-computational in nature, for example a user inputting data into the apparatus 1002. A computational operation 1010 in the workflow 1008 may be divided into a plurality of sub-computational operations. These sub-computational operations may be required to be performed in parallel or in series. The sub-computational operations may be associated with sub-tasks as previously described wherein a sub-task of the main task request 1014 may require a plurality of operations to be computed sequentially or in parallel.

### User Input

As described above, at least one required computational operation 1010 determined by the method 1019 and apparatus 1002 requires a user input 1028. This user input 1028 may be any input in principle that is accepted by the apparatus 1002 or method 1019 and interacts via the interactive graphical image element 1016. A user may use any input device 1038 to input the information or data into the workflow 1008 via the interactive graphical image element 1016. Input devices 1038 may include one or a combination of any of: a touch sensitive portion of the graphical user interface 1006, a mouse, a tracker ball, a keyboard or keypad, a microphone interacting with speech to text recognition software. The user input 28 may be any of, but not limited to, a selection of a check box, the selection of a particular button or icon or other graphical element associated with the interactive graphical image element 1016 on the graphical user interface 1006 by clicking a pointing device such as a mouse or typing a string of characters such as words, numbers or an alphanumeric composition of characters.

### Graphical User Interface (GUI)

The graphical user interface 1006 is, in principle, any program interface that utilises a graphical display 1018 providing capability to allow a user to interact with the workflow 1008. Typically the graphical user interface 1006 is a type of interface that allows users to interact with electronic devices of the apparatus 1002 (such as the processor 1012) through graphical icons and visual indicators. The actions performed in a graphical user interface 1006 are typically performed through direct manipulation of graphical elements displayed by a display device 1018.

### Apparatus

The apparatus 1002 comprises the processing device 1012 and optionally any other electronic or optical devices, such as electronic devices providing the graphical user interface 1006 (such as a display device 1018 incorporating a touch pad or touch screen or other input devices). The apparatus 1002 may also include other computational devices such as a memory device 1036 and input/output circuitry and devices 1038, for example as shown in FIGS. 7 and 17.

The processor device 1012, and optionally other computational elements that interact with the processing device 1012, may be configured to provide one or more different computational engines. These computational engines are configured to perform certain aspects of the workflow 1008. In one example, the computational engines may be provided via software modules or elements of software modules and/or hardware.

The processor device 1012 may be part of a central processing unit (CPU). The central processing unit may comprise an arithmetic logic unit (ALU) that performs arithmetic and logic operations. The CPU may also comprise hardware registers that supply operands to the ALU and store the results of the ALU operations. The central processing unit may also comprise a control unit that fetches instructions from memory 1036 and executes them by directing the coordinated operations of the ALU, registers and other computational components. An example of a CPU is a microprocessor, for example one contained on a single integrated circuit (IC) chip. An IC that contains a CPU may also contain memory 1036, peripheral devices (for example input/output devices 38) and other components of a computer device. Such integrated devices may also be termed ‘microcontrollers’. The apparatus 1002 may also comprise a graphics processing unit (GPU). The GPU is a purpose built device that assists the CPU in performing complex rendering calculations.

The graphical user interface 1006 outputs data for display using at least a display device 1018. The display device 1018 may in principle be any device that displays characters or graphics representing data. A display device 1018 may output data in 2D and/or 3D format. An example of a 2D display device 1018 is a computer display screen. An example of a 3D display device 1018 is a 2D display viewed with external optical apparatus such as polarised glasses which together produce a 3D effect to the user wearing the glasses. Another example of a 3D display device 1018 is a volumetric display device that is a graphical display device 1018 that forms a visual representation of an object in three physical dimensions.

### Interactive Image Object

The interactive image object 1048 is the data generated by the processor 1012 and used to display (via the GUI) one or more graphical image objects 1004 with one or more interactive graphical image elements 1016. The interactive image object 1048 provides the required data that enables the interactive graphical image element 1016 to accept a user input 1028. The interactive image object 1048 may therefore comprise data 1048 associated with the graphical make-up of the graphical image object 1004, for example sizes, shapes, colours and other such configurations when the interactive image object 1048 is displayed using the graphical user interface 6.

The interactive image object 1048 may be created in any suitable way including creating an image data file or scene file containing code for producing the graphical image object 1004. The generation of the image data or image code of the interactive image object 1048 may be achieved using a scene generation engine. The interactive image object 1048 may also comprise metadata associated with the graphical image object 1004. Such metadata may include data 1052 providing interactivity between the user and the computational workflow 1008 allowing the user input 1028 to be input via the interactive graphical image element 1016. The image data 1050 used to form the graphical image object 1004 and the interactive graphical image element 1016 is typically passed as one or more scene files containing the scene data to a rendering engine.

Examples of the interactive graphical image element 1016 include a text box or a check box wherein other image objects of the graphical image object 1004 may wrap at least partially (preferably fully) around the interactive graphical image element 1016 thereby creating a “theme”. This theme may resemble an interactive form that the user can interact with.

FIG. 10 shows an example of a graphical image object 4 having two interactive graphical image elements 1016 that a user can interact with by providing user input 1028. The graphical image object 1004 is shown to comprise the text “Enter Task” above an element 1016 that provides a text entry field. The text entry interactive element 1016 is adjacent a further interactive graphical image element 1016 labelled with the word “GO”. The interactive image object 1048 that was rendered to produce this graphical image object 1004 comprised image data 1050 for defining the image and interactive metadata 1052 defining the interactivity portions of the image object 1004.

In principle the interactive graphical image element 1016 may be the entire graphical image object 1004. A graphical image object 1004 comprising an interactive image element 1016 may be seen, in some examples as a form whereby the user can provide the user input 1028. In principle there may be more than one interactive graphical image element 1016 associated with the graphical image object 1004 as discussed above and shown in FIG. 10. Furthermore the processor device 1012 may be configured generate an interactive image object 1048 to comprise one or more graphical image objects 1004 wherein each graphical image object 4 comprises one or more interactive graphical image elements 1016.

The image data 1050 (of the interactive image object 1048) used to form the visual appearance of the graphical image object 1004 may be located with or formed as part of a set of data for outputting a larger graphical image, the graphical image object 1004 forms a part of the larger image. An example of this is the graphical output of an operating system desktop whereby a portion of the graphical output is associated with the graphical image object 1004 whilst the rest of the data used to define the display image is attributable to the appearance of the background operating system desktop.

The image data 1050 of the interactive image object 1048 may be defined in any suitable way including raster graphics coding (digital image comprising a grid of pixels) and/or vector graphic coding (where representation of the graphical object 1004 is made via items such as lines, arcs, circles and rectangles and achieved through mathematical formulas such as post script).

The interactive graphical image element 1016 may also be known as an interface element, a graphical control element or a widget. The element 1016 is an element of interaction in a graphical user interface 1006 that a user interacts with through direct manipulation to read or edit information about the workflow 1008. Examples of such elements 1016 include, but are not limited to, text input boxes, buttons such as check boxes, sliders, list boxes and drop down lists. Each type of element 1016 facilitates a specific type of user-workflow interaction, and appears as a visible part of the workflow's graphical user interface 1006 as rendered by a rendering engine.

Context Data Associated with the Workflow

Context data is associated with the workflow 1008 and may, in principle, be any information associated with or relevant to the current step in a particular task. This association may be current information or historical information. For example, context data could be the number of user inputs 1028 required for the required operation 1010.

Context data may be obtained in any way in principle including, but not limited to, determining the context data using the task request, receiving the context data from an input device such as a keyboard, or through a communications device receiving data from an external data source.

Context data may be at least partially generated by the apparatus 1002 by performing a calculation using various different data (for example determining an output display capacity by comparing and evaluating information about the physical display size of the portable device and information about the associated graphics card linked to the display) and/or extracting or mining information from one or more data sources (for example a user manually inputs a text string describing the workflow, the apparatus examines the string and searches for certain keywords, the combination of the keywords found are used to generate the context data.

Context data may be used, at least in part, to determine the required computational operation.

Context data may be associated with the current task or task request 1014. In this example the context data may include data associated with previous (historical) user inputs 1028 provided within the workflow 1008.

Context data may also be associated with the graphical user interface 1006. An example of this type of context data could be the display 1018 size or resolution used by the graphical user interface 1006.

Context data may also be associated with the user providing the user input 1028. An example of this could be the sex of the user, wherein the sex dictates where the interactive graphical image element 1016 is located on display device 1018 used by the graphical user interface 6. This may be important because the screen is very wide, due to men's and women's different levels of peripheral vision. Hence this context data may be used by an element 1016 layout rule to put all the elements 1016 in a centre stacked formation for a man, but allow the same elements 1016 to be distributed width ways on the screen for a woman.

### Object Generation Rules

The object generation rules used by the method 1019 and apparatus 1002 described herein, maybe any command or data structure that provides one or more instructions and/or one or more limiting parameters to create the interactive image object 1048. The rules may include details as to how the processor 1012 generates the image data portion of the interactive image object 1048 that corresponds to the appearance of the graphical image object 1004. This may include the graphical configuration or layout of the interactive graphical element 1016, for example where an element 16 is positioned about the graphical image object 1004, the size of the element 16 (for example, how large the element 1016 is either absolutely or relatively compared to other graphical objects), and any other rules or information determining the configuration of the interactive graphical image element 1016 within or about the graphical image object 1004.

The rules may include details for the rendering of any metadata 1052 within the interactive image object 1048 associated with the interactive graphical image element 1016. An example for the rendering of such metadata is where an interactive “hot-spot” is provided for the interactive graphical image element 1016. The “hot-spot” being the location within the graphical environment displayed by the graphical user interface 1006 which the user must select using an input device 1038 (such as a pointing device) to cause the activation of the interactive graphical image element 1016.

The object generation rules may be stored on any suitable electronic or optical storage device such as a memory device 1036 associated with the apparatus 1002 (for example being part of the apparatus). The rules may additionally or alternatively be stored on a remote memory device such as being contained within a cloud computing environment. The rules may be contained in a rules database 1032 that is accessed by the processor device 1012 in order to generate the interactive image object 1048.

The rules may be conditional or unconditional in nature. The apparatus 1002 and method 1019 may be configured to conditionally select a rule for application. The conditional application of a rule may be based upon context data. Additionally or alternatively, some rules may be unconditionally applied.

The rules themselves may also have conditional or unconditional outputs or instructions that are subsequently used by the apparatus 1002 and method 1019 to generate the interactive image object 1048. A rule with a conditional output is one where the output instruction of the rule is conditional upon an input (such as context data), hence the rule can output a plurality of different instructions used by the processor 1012 to generate the interactive image object 1048.

The apparatus 1002 and method 1019 may therefore provide any of: the conditional application of an unconditional rule; a conditional application of a conditional rule; an unconditional application of an unconditional rule; or an unconditional application of a conditional rule.

A conditional application of an unconditional rule could be, for example, when it is determined, from context data, that only a single user input 1028 is required for a particular operation 1010. In this example the rule of “single tab only” is referenced and used to create the interactive image object 1048.

An example of how the output of a rule is conditional is where context data is supplied that shows that the display screen 1018 size is limited. In this example the rule may have a number of conditions of how the object 1004 is to be output. This rule may stipulate that: if the screen size is less that 600×600 pixels and the type of user input 1028 is a text string (for example a first and last name) then use of two vertically stacked user input text boxes to input the first and corresponding second half of the string are used; but if the screen size is greater than or equal to 600×600 pixels then the rule instructs to display a single textbox for inputting the whole string (i.e. a single textbox for inputting the first and last name).

### Examples of Workflows According to the Method as Described Herein.

FIG. 8a shows an example of a method 1019 for a workflow 8 wherein the workflow comprises the computation operation 1010 step of determining the required computation operation 1020 as previously described above. After determining the required computation operation (the operation requiring the user input 1028) the workflow 1008 then generates 1022 the interactive image object 1048 for the display. After generating the object 1008 data for display as described above, the workflow then outputs 1024 the interactive image object 1048 for display.

FIG. 8b shows a further example of a workflow 1008 similar to FIG. 8a whereby after the step 1024 of outputting the interactive image object 1048 for display, the workflow 1008 then displays 1026 the interactive image object 1048, the user then provides a user input 1028 via the interactive graphical image element 1016 of the graphical image object 1004. Upon receiving the user input 1028, the workflow 1008 then computes the required computational operation at step 1030.

FIG. 9 shows a workflow 1008 according to the method 1019 described herein when there is provided an input task request 1014 whereby steps 1020 and 1021 correspondingly determine the required computational operation 1010 and determine the required user input 1028 associated with the required operation 1010. The determined operation and user input 1028 are provided into the next step 1022 which generates the interactive image object 1048. A rules database 1032 is used to provide rules for the generation of the interactive image object 1048. Furthermore, context data is input at step 1034 into step 1022 wherein one or more object generation rules are applied based on the context data. The interactive image object 1048 generated at step 1022 is then output for display at step 1024. Step 1026 is a computational operation that displays the interactive image object 1048 via the graphical user interface 1006 through which the user provides the user input. Similarly to FIG. 8b, the next step in the workflow for FIG. 9 could also be the step 1030 of computing the required operation.

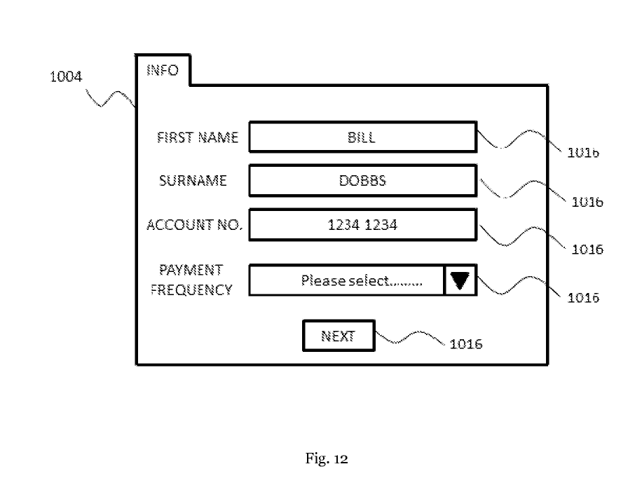

FIG. 11 shows an example of a graphical image object 1004 comprising four tabs 1040. Such an object 1004 may be displayed as part of a rental property program where a user is presented with a different user interface page to navigate via the tabs 1040. The user fills in the text boxes with data and then selects the element 1016 labelled ‘next’ to take them to the next tab 1040 or to another new interface page. Instead of displaying a complex graphical object 1004 with multiple tabs 1040, the method 1019 and apparatus 1002 may sequentially display each tab 1040 to the user, for example as shown in FIG. 12, which shows no tabs 1040. The selection of ‘next’ in this example will cause the processor 1012 to generate a new graphical image object for separately displaying another one of the tabs 1040.

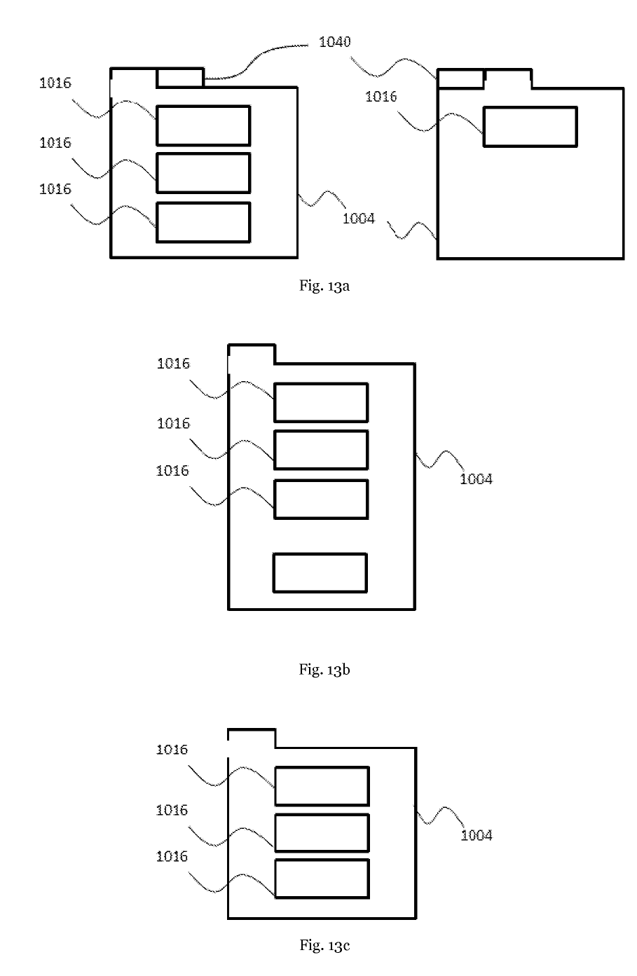

FIG. 13a shows an example of a nominal template based GUI with multiple tabs 1040, wherein four interactive elements 1016 are split between the two tabs 1040. FIG. 13b shows an example where the apparatus 1002 uses context data (for example the display screen being large), applied to an object layout rule, to change the layout to have all of the elements 1016 on one tab. FIG. 13c shows an example where the apparatus 1002 uses context data (for example the display screen being small), applied to an object layout rule, to change the layout to have each tab sequentially displayed with FIG. 13c showing the first of those original tabs.

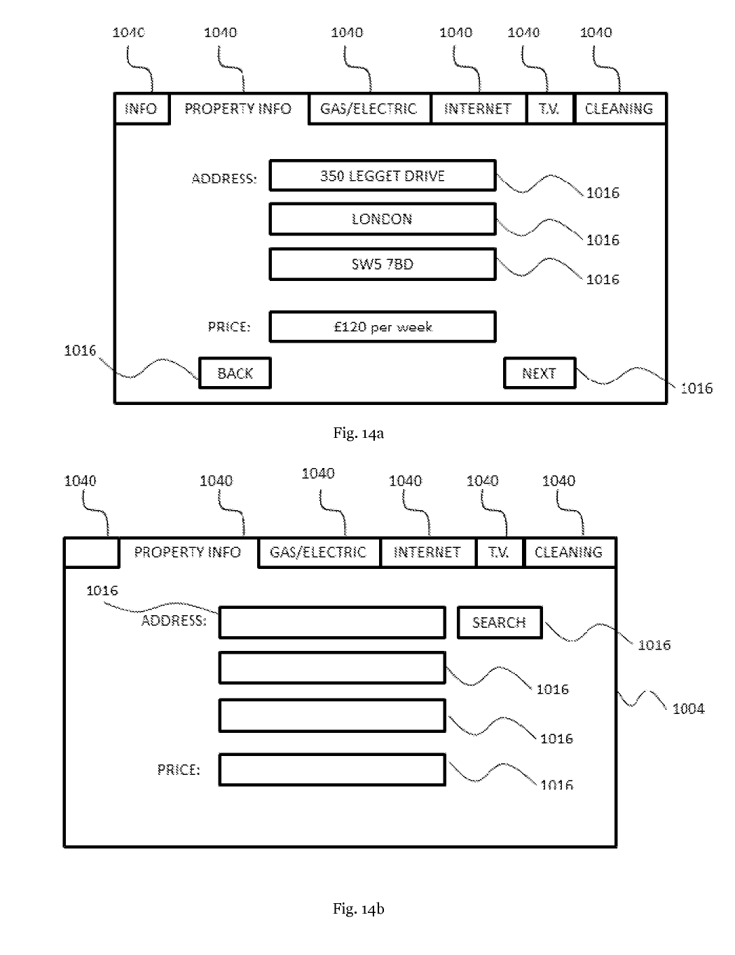

FIG. 14a shows a further example of a template that may be used for a rental property workflow 1008. The template may have multiple tabs 1040, each having multiple input elements 1016. FIG. 14b shows an example where context data indicates that the data requested by the ‘INFO’ tab has already been input elsewhere in the workflow 1008 or has been extracted from another information source. In this example the apparatus does not provide a tab for the ‘INFO’.

In the example shown in FIG. 14b the user is provided with an address search function. The resulting found data may, in one example, be used to determine the data required in the ‘INFO’ tab 1040. Therefore the workflow 1008 may not display this tab 1040 until the resulting searched data is obtained. If the INFO data can be derived from using the address data (for example by looking up the address on a national register of voters), then the INFO tab is left removed, however if the INFO data cannot be obtained in this way, the tab is dynamically inserted back into the user interface similar to FIG. 14a.

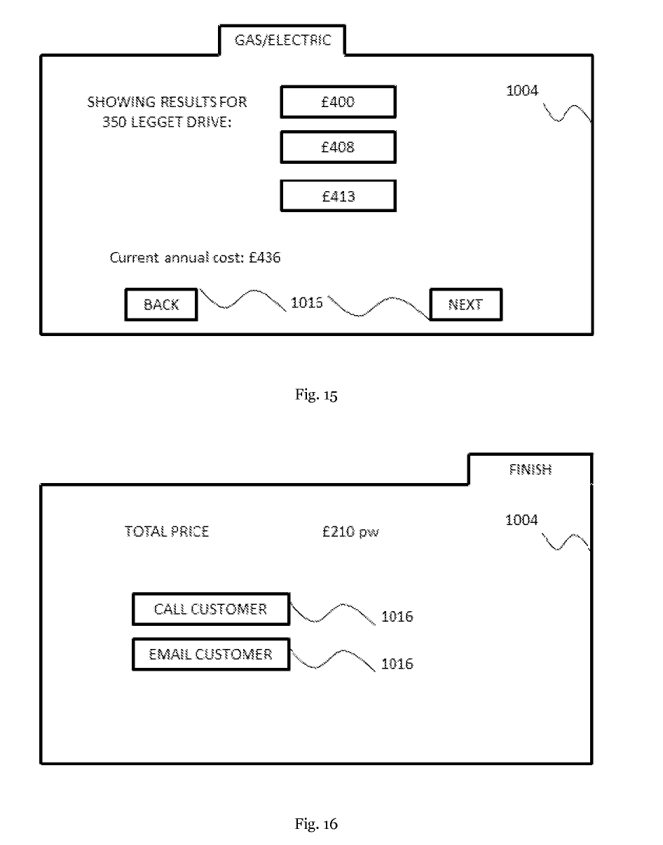

FIG. 15 shows an alternative example to how tabs 1040 in this example could be displayed. In this example, the tabs 1040 are displayed sequentially. This workflow adaption may, for example, be initiated if the INFO data entered on the first tab indicated the user was very old and not used to using computers. Upon receiving this data, the apparatus 1002 uses this as context data, used by a layout rule to minimise the complexity in the GUI 1006.

FIG. 16 shows an example of a GUI page at the end of the rental workflow 1008 where all the user data has been input into the tabs 1040 and a new GUI page is displayed with the results of the global computation with optionally selectable elements 1016 that the user can select outside of compulsory operations of the workflow 1008.

In another example, the workflow 1008 may require a number of types of user input split into different subject categories or ‘themes’, each theme requiring one or more user inputs. Instead of having a single predefined template for outputting on a GUI with each theme tabbed and the tabbed graphical contents are predefined; the method 1019 and apparatus 1002 may provide a dynamic approach to providing the workflow. Rules may be used by the processor 1012 that provide a generic graphical layout unrelated to a particular theme. In one example, this rule may not be dependent on context data, for example one generic rule may require four graphical input elements 1016 for each theme. Other rules that are context dependent may be used to supplement the generation of the graphical layout data 1050 in the interactive image object 1048. For example, a context dependent rule may be used that provides different layout generation instructions dependent upon the theme intended to be displayed by the GUI 1006. Using the example shown in FIG. 14b, the apparatus 102 or method 1019 may use the generic graphical layout rule that requires all themes to have a page with four stacked interactive graphical elements 1016. The workflow 1008, when run by the method 1019 presented herein, may sequentially output each theme instead of using a multiple tabbed object, wherein each theme is separately generated as an interactive image object 1048. Also used in the generation of each interactive image object 1048 is a rule the dictates what text is to be displayed next to each of the four elements 16.

FIG. 17 shows an example of an apparatus 1002 that forms part of a client-server relationship wherein the GUI 1006 is hosted by one or more remote devices 1044 (also referred to as ‘GUI apparatus’ in this example). The apparatus 1002 (also referred to herein as a ‘server’) comprises one or more processors 1012 and memory devices 1036 that operate together with other electronic components and circuitry to run one or more programs configured to provide the functionality require by the apparatus 1002 or the method 1019 as presented herein. The apparatus 1002 in this example comprises one or more communication devices 1038 configured to at least transmit data to the remote devices 1044. In turn, the GUI apparatus 1044 in this example has electronic access with one or more communication devices configured to receive data from the server 1042. Such data may be, but is not limited to, an interactive image object 1048.

An example of a workflow 1008 run using such a client-server setup is a workflow 1008 for managing an installation of a communications system within a customer premises. An installation engineer may have access to a portable device 1044 having a display (for supporting a GUI), an input device (such as a touch screen), processor and memory devices, and a communications device for receiving and transmitting data to and from the server 1042. An example of such a portable device 1044 could be a mobile phone 1041 or a tablet 1043.

The server 1042 runs software for implementing the method 1019 presented herein that controls the workflow 1008 and generation of the interactive image objects 1048.

As the installation engineer performs the installation of the new system in the customer premises, they follow a workflow graphically output from a GUI 1006 displayed on the portable device display.

In this example the server 1042 may be sending workflow 1008 interactive image objects 1048 to a number of different engineers at different customer sites, each engineer having a portable device 1044. Each engineer may be performing the same type of installation (hence same global task), however the server 1042 may output a different series of workflow steps to each portable device 1044 dependent upon the context of the specific installation. This allows each engineer to interact with a custom dynamic workflow 1008 that takes into account the needs, requirements and situations of that particular installation. For example, one customer premises may be in a remote geographical area. The server therefore assesses the strength (e.g. data rate) of the communication links between itself 1042 and the portable device 1044. If the links are strong, then the workflow 1008 may be divided up into lots of smaller interactive steps (e.g. each interactive image object 1048 has one or two interactive image elements 1016) due to the ease of uploading and downloading data to and from the server 1042. However if the communication links are not strong, for example being below a threshold data rate, then the interactive image objects 1048 sent to the portable device 1044 may have a greater number of interactive image elements 1016 due to the difficulty in repeatedly sending data to the portable device 1044 (i.e. it becomes more efficient to send data in larger packets than smaller ones).

In the example above a rule may exist that uses context data concerning communication capability between the client 1044 and server 1042 and uses that data to determine the number of user inputs collected per information packet sent back to the server 1042.

Rules may be provided to determine other properties and parameters associated with the interactive image objects 1048. These other properties may be any parameter concerning the outputting (e.g. sending of the graphical image objects) for display, for example when to send the object 1048 and where to send it. In the above server example, context data may be determined or otherwise received that indicated poor data communications between a portable device 1044 and the remote server 1042 and that the portable device 1044 had a low resolution or small screen size. A task request is generated from a previous step in the workflow 1008 that requires two or more user inputs. One rule used by the processor 1012 may determine that only one interactive image element 1016 be displayed at any one time on the portable display due to screen size constraints. However another rule may determine that each interactive image object 1048 sent from the server 1042 to the portable device 1044 should contain data for outputting multiple interactive image objects 1048 due to the poor communications capabilities. The poor communication capabilities would nominally lead to an undesirable time lag in inputting user data and waiting for the next new interactive page of the workflow 1008 to be sent back. In this situation where rules may conflict, another rule may be implemented to provide a workable solution to the conflicting rules. In this example a further rule is used that constructs an interactive image object 1048 that contains instructions (for example, metadata 1054 or a set of code that can be run by the portable device 1044) for sequentially outputting a plurality of graphical objects. Hence executable code is sent to locally execute a plurality of workflow steps. This data 1054 may also be configured to instruct the portable display to only send back the collected user data once all of the sequential user inputs have been collected.

In another example, the apparatus 1002 may determine a plurality of required operations and use data (such as context data) to determine a priority ranking for each of the required operations. Upon determining the priority ranking, the apparatus 1002 generates the next and subsequent graphical image objects 1048 based upon the priority ranking. For example, two operations are required, one of which requires a user input that may affect the need for the other operation. In this example the ‘user input’ operation is prioritised higher than the other so that the interactive image object 1048 is generated and output before the other.

The present invention has been described above with reference to a number of exemplary embodiments and examples. It should be appreciated that the particular embodiments shown and described herein are illustrative of the invention and its best mode and are not intended to limit in any way the scope of the invention as set forth in the claims. It will be recognized that changes and modifications may be made to the exemplary embodiments without departing from the scope of the present invention, as expressed in the following claims.

1. An apparatus for generating and outputting an interactive image object for display using a graphical user interface, the interactive image object associated with a computational workflow comprising a sequence of computational operations, the apparatus comprising a processor device configured to:
determine a required computational operation for the workflow based upon a task request, the operation requiring a user input;
generate the interactive image object based upon one or both of the determined computational operation or required user input;
by applying, based on context data associated with the workflow, one or more object generation rules determining the configuration of the interactive image object; and
output the interactive image object for display.

2. The apparatus as claimed in claim 1 wherein the interactive image object, when displayed by the graphical user interface, appears as a graphical image object comprising an interactive graphical image element for receiving the user input.

3. The apparatus as claimed in claim 1 wherein the object generation rules at least determine the graphical configuration of the interactive graphical image element within the graphical image object.

4. The apparatus as claimed in claim 1 wherein the processor device is configured to determine the relative positions of a plurality of interactive graphical elements within the graphical image object.

5. The apparatus as claimed in claim 1 wherein the task request is based on a previously received user data input.

6. The apparatus as claimed in claim 1 wherein the processor device is configured to determine the context data using the task request.

7. The apparatus as claimed in claim 1 wherein the processor is further configured to:
determine a plurality of required computational operations;
assign a priority value to each of the plurality of operations; and
generate the interactive image object based on the priority.

8. The apparatus as claimed in claim 1 further comprising a communication device for transmitting the interactive image object to a remote device for display.

9. A method for generating and outputting an interactive image object for display using a graphical user interface, the interactive image object associated with a computational workflow comprising a sequence of computational operations, the method comprising:
determining a required computational operation for the workflow based upon a task request, the operation requiring a user input;
generating, using a processor, the interactive image object based upon any one or more of, the determined computational operation or required user input;
by applying, based on context data associated with the workflow, one or more object generation rules determining the configuration of the interactive image object; and,
outputting the interactive image object for display.

10. The method as claimed in claim 9 wherein the interactive image object, when displayed by the graphical user interface, appears as a graphical image object comprising an interactive graphical image element for receiving the user input.

11. The method as claimed in claim 9 wherein the object generation rules at least determine the graphical configuration of the interactive graphical image element within the graphical image object.

12. The method as claimed in claim 9 wherein the processor device is configured to determine the relative positions of a plurality of interactive graphical elements within the graphical image object.

13. The method as claimed in claim 9 wherein the processor device is configured to determine the context data using the task request.

14. The method as claimed in claim 9 wherein the processor is configured to determine the required computational operation using the context data.

15. The method as claimed in claim 9 wherein the processor is further configured to:
determine a plurality of required computational operations;
assign a priority value to each of the plurality of operations; and
generate the interactive image object based on the priority.

16. The method as claimed in claim 9 further comprising the step of transmitting the interactive image object to a remote device for display using a communication device.

17. A computer readable medium comprising computer readable instructions configured to give effect to the method as claimed in claim 9.
